(19) United States
(12) Patent Application Publication
(10) Pub. No.: US 2011/0198190 A1
(43) Pub. Date: Aug. 18, 2011

(54) PARKING LOCK SYSTEM

(75) Inventors: Klaus STEINHAUSER, Kressbronn (DE); Thilo SCHMIDT, Meckenbeuren (DE); Jens WAGNER, Langenargen (DE); Herbert KIEBLER, Tettnang (DE)

(73) Assignee: ZF FRIEDRICHSHAFEN AG, Friedrichshafen (DE)

(21) Appl. No.: 13/029,255

(22) Filed: Feb. 17, 2011

(30) Foreign Application Priority Data
Feb. 17, 2010 (DE) 10 2010 002 021.4

(51) Int. Cl. B60T 1/06; F16H 63/48; F16H 57/10

(52) U.S. Cl. 192/219.5

(57) ABSTRACT

A vehicle transmission parking lock system comprising a parking lock for locking or releasing the transmission, an operating device of the vehicle which is electrically connected to the parking lock, a spring for engaging the parking lock, a pressure-controlled release device for disengaging the parking lock, a holding device for securing the parking lock in a released and/or engaged condition, and an emergency release device of the parking lock. When the vehicle drive assembly is static due to the occurrence of a defined event, the emergency release device actuates a device to release the parking lock under pressure control. The holding device retains the parking lock in the released condition for as long as the emergency release device is activated, and the defined event which triggers actuation of the pressure-controlled release device of the parking lock occurs when at least two operating devices are actuated in a defined manner.

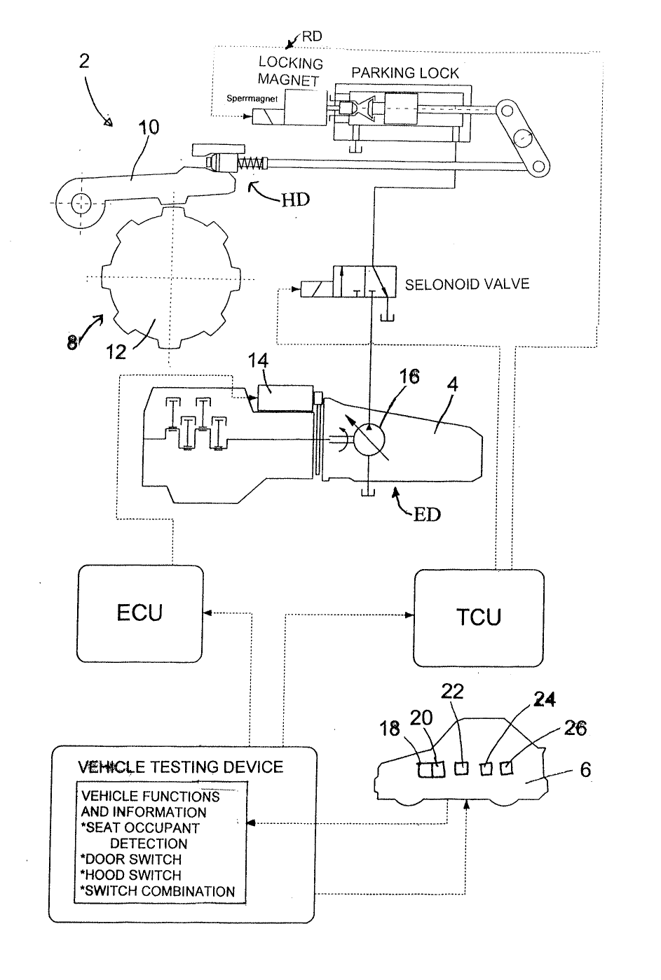

This application claims priority from German patent application serial no. 10 2010 002 021.4 filed Feb. 17, 2010.

### FIELD OF THE INVENTION

The invention concerns a parking lock system.

### BACKGROUND OF THE INVENTION

From DE 101 28 430 B4 a parking lock system for a transmission of a motor vehicle is known, which comprises a parking lock for blocking or releasing the transmission, in particular by engaging and locking or disengaging and releasing a locking pawl in a parking lock gearwheel connected to a drive output of the transmission, with an active electrical connection between an actuating device, within the inside space of the motor vehicle, and the parking lock, a spring for engaging the parking lock, a pressure-controlled parking lock release device for disengaging the parking lock, a holding device for securing the parking lock in its disengaged condition and/or in its engaged condition, and a parking lock emergency release device. According to DE 101 28 430 B4, when the drive assembly of the motor vehicle is static, this being triggered by a defined event, namely a P-N shift command from a selector lever of the transmission, the emergency release device actuates a device, namely a starter of the drive assembly, in order to disengage the parking lock under pressure control, the parking lock then being secured in its released condition by the holding device and remaining so secured for as long as the emergency release device is still activated.

### SUMMARY OF THE INVENTION

Starting from there, the present invention addresses the problem of providing a new type of parking lock system. According to the invention, the defined event that triggers the actuation of the device for the pressure-controlled release of the parking lock occurs when at least two operating devices are or have been actuated at the same time or in a definite, timed sequence.

The parking lock system according to the invention is characterized by improved and more reliable actuation of the device for the pressure-controlled disengagement of the parking lock by the emergency release device.

In an advantageous further development of the invention the emergency release device actuates the device for the pressure-controlled release of the parking lock until a parking lock sensor detects that the parking lock has been released and/or for a maximum time. In this way the device for the pressure-controlled release of the parking lock is protected against overly-long actuation by the emergency release device.

### BRIEF DESCRIPTION OF THE DRAWING

Preferred further developments of the invention emerge from the description given below, in which an example embodiment of the invention, to which it is not limited, is explained in more detail and shown in the accompanying drawing. The sole drawing is a diagrammatic representation of an embodiment of a parking lock system for a transmission of a motor vehicle according to the invention.

### DETAILED DESCRIPTION OF THE PREFERRED EMBODIMENTS

The present invention concerns a parking lock system 2 for a transmission 4 of a motor vehicle 6.

Such a parking lock system 2 comprises a parking lock 8 for blocking or releasing the transmission 4, in particular by engaging and locking or disengaging and releasing a locking pawl 10 in or from a parking lock gearwheel 12 connected to a drive output of the transmission 4. The parking lock 8 can be engaged by a spring, and can be disengaged by a pressure-controlled release device.

In addition, the parking lock system 2 comprises a holding device (generally designed as HD) for securing the parking lock 8 in its disengaged and/or engaged condition. Thus, by means of the holding device HD the parking lock 8 can be secured both after being disengaged and after being engaged.

Besides the parking lock 8, the spring, the pressure-controlled release device RD and the holding device HD, the parking lock system 2 also comprises an emergency release device ED for the parking lock 8, such that when the drive assembly of the motor vehicle 6 is static, due to the occurrence of a defined event, the emergency release device ED actuates a device, e.g., RD and HD, to release the pressure lock in a pressure-controlled manner. In its disengaged condition, the parking lock 8 can be secured and preferably remains secured in the condition for as long as the emergency release device ED is still actuated.

In the context of the present invention, the defined event which triggers actuation of the device ED for the pressure-controlled release of the parking lock 8 occurs when at least two operating devices, positioned inside the motor vehicle 6, are or have been actuated at the same time or in a defined, timed sequence. Thus, in the context of this invention the emergency release device ED only actuates the device RD for the pressure-controlled release of the parking lock 8 when a defined combination of operating devices within the motor vehicle 6 is actuated at the same time or in a defined, timed sequence.

One of the operating devices can be the transmission selector lever 18 which, for the defined event, must be moved from shift position P to shift position N so that a shift command P-N is issued. A transmission selector lever 18 of this type is usually also combined with a so-termed “Shift-Lock” 20 by virtue of which brake pedal information influences the possible shift position of the transmission selector lever.

Another of the devices can be a switch 22 or key in the interior of the motor vehicle 6, by means of which a shifting mode in the transmission, in particular between sporty shifting and comfortable shifting, can be influenced. Such a switch 22 is in particular a ‘sporty’ switch integrated in a cockpit of a motor vehicle 6.

Moreover, another operating device which must be actuated in combination with at least one other operating device at the same time or in a defined, timed sequence to implement the defined event can be any operator interface 24 within the motor vehicle 6.

Furthermore, in the context of the present invention it is possible for the defined event, that triggers the actuation of the device RD for the pressure-controlled disengagement of the parking lock 8, to occur when an appropriate command is delivered to a maintenance interface 26 of the motor vehicle or to a connection interface 26 for a keyboard. Also, in this case a combination with one of the above operating devices can be required.

Between the operating devices inside the motor vehicle 6, namely, the maintenance interface 26 of the motor vehicle 6 or the connection interface for a keyboard, and the parking lock 8, there is an active electrical connection.

The device RD for the pressure-controlled release of the parking lock 8, which is actuated by the emergency release device ED when the defined event occurs, can be a starter 14 of the motor vehicle 6 coupled to a transmission-internal hydraulic pump 16. Alternatively, the device ED can also be an electric machine of a hybrid drive, which can be coupled to a transmission-internal hydraulic pump or to a transmission-external auxiliary hydraulic pump 16. It is also possible that the device RD for the pressure-controlled release of the parking lock 8, which is actuated by the emergency release device ED when the defined event occurs, be a hydraulic pulse accumulator or some other hydraulic storage device of the motor vehicle.

According to an advantageous further development of the present invention, the emergency release device ED actuates the device RD for the pressure-controlled release of the parking lock 8 until a parking lock sensor detects that the parking lock 8 has been released.

If the release of the parking lock 8 is not detected, the device RD for the pressure-controlled release of the parking lock 8 is actuated by the emergency release device ED in a time-controlled manner for a defined maximum time in order to prevent the device RD for the pressure-controlled release of the parking lock 8 from being actuated for too long a time. In this way, damage to the device can be avoided or an unexpected reaction because of the long actuation time can be prevented.

Alternatively, the actuation of the device RD for the pressure-controlled release of the parking lock 8 by the emergency release device ED can be exclusively time-controlled, and in that case the device RD for the pressure-controlled release of the parking lock 8 is always actuated by the emergency release device ED for a defined time only.

In terms of control, the emergency release device ED can be integrated in a transmission control unit TCU or a drive assembly control unit ECU or in a hybrid control unit of a hybrid vehicle. The emergency release device ED can then be implemented centrally in a single control unit or in a decentralized manner in a plurality of control units.

1-10. (canceled)

11. A parking lock system for a transmission of a motor vehicle, the parking lock system comprising:
a parking lock for either blocking or releasing the transmission by respectively engaging or disengaging a locking pawl in a parking lock gearwheel connected to a drive output of the transmission,
an active electrical connection between an operating device in an inside space of the motor vehicle and the parking lock,
a spring for engaging the parking lock,
a pressure-controlled release device for disengaging the parking lock,
a holding device for securing the parking lock in at least one of a released and an engaged condition,
an emergency release device of the parking lock such that, when a drive assembly of the motor vehicle is static due to an occurrence of a defined event, the emergency release device actuates a device to release the parking lock under pressure control, and the parking lock being securable in the released condition by the holding device and the parking lock remaining secured in the released condition for as long as the emergency release device is activated,
the defined event, which triggers the actuation of the device for the pressure-controlled release of the parking lock, occurs when at least two operating devices either are or have been actuated either at a same time or in a defined timed sequence.

12. The parking lock system according to claim 11, wherein one of the two operating devices is a transmission selector lever which, as the defined event, must be moved from a parked shift position (P) to a neutral shift position (N).

13. The parking lock system according to claim 11, wherein one of the two operating devices is either a switch or a key which influences a shifting mode between a sporty shift mode and and a comfortable shift mode.

14. The parking lock system according to claim 11, wherein the defined event that triggers actuation of the device, for the pressure-controlled release of the parking lock, also occurs when a corresponding command is delivered to a maintenance interface.

15. The parking lock system according to claim 11, wherein the device to be actuated for the pressure-controlled release of the parking lock when the defined event occurs, is a starter of the motor vehicle which is coupled to a transmission-internal hydraulic pump.

16. The parking lock system according to claim 11, wherein the device to be actuated for the pressure-controlled release of the parking lock, when the defined event occurs, is an electric machine of a hybrid drive, which is coupled to a transmission-internal hydraulic pump.

17. The parking lock system according to claim 11, wherein the device to be actuated for the pressure-controlled release of the parking lock, when the defined event occurs, is an electric machine of a hybrid drive, which is coupled to a transmission-external hydraulic pump.

18. The parking lock system according to claim 11, wherein the device to be actuated for the pressure-controlled release of the parking lock, when the defined event occurs, is a hydraulic accumulator.

19. The parking lock system according to claim 11, wherein the emergency release device actuates the device for the pressure-controlled release of the parking lock until a parking lock sensor detects that the parking lock has been released.

20. The parking lock system according to claim 11, wherein the emergency release device actuates the device for the pressure-controlled release of the parking lock for a defined maximum time.

21. A parking lock system for a transmission of a motor vehicle, the parking lock system comprising:
a locking pawl being releasably engagable with a parking lock gearwheel which is connected to a drive output of the transmission, the locking pawl being actuated to either engage and lock a parking lock or disengage and unlock the parking lock, via the parking lock gearwheel;
a first operating device located in an interior of the motor vehicle and being connected to the parking lock by an active electrical connection;
a spring engaging the parking lock;
a pressure-controlled release device for disengaging the parking lock;
a holding device for contacting and securing the parking lock in at least one of an engaged condition and a disengaged condition;
an emergency release device of the parking lock communicating with and actuating the pressure-controlled release device, when a drive assembly of the motor vehicle is static as a result of a defined event, for releasing the parking lock; and
the holding device for securing the parking lock in the disengaged condition until the emergency release device is activated, and the defined event being one of simultaneous actuation of the first operating device and a second operating device or actuation of the first operating device and the second operating device in a defined, timed sequence.
